(19) United States
(12) Patent Application Publication
(10) Pub. No.: US 2022/0078883 A1
(43) Pub. Date: Mar. 10, 2022

(54) PUBLIC WARNING SYSTEM ENHANCEMENT

(71) Applicant: IPCom GmbH & Co. KG, Pullach (DE)

(72) Inventors: Andreas SCHMIDT, Braunschweig (DE); Achim LUFT, Braunschweig (DE); Maik BIENAS, Schöppenstedt (DE); Martin HANS, Bad Salzdetfurth (DE)

(73) Assignee: IPCom GmbH & Co. KG, Pullach (DE)

(21) Appl. No.: 17/417,770

(22) PCT Filed: Jan. 27, 2020
(86) PCT No.: PCT/EP2020/051936

§ 371 Date: Jun. 24, 2021

(30) Foreign Application Priority Data
Jan. 29, 2019 (EP) 19154136.6

(51) Int. Cl. H04W 76/50; H04W 4/90; H04W 4/06; H04W 4/50

(52) U.S. Cl. CPC H04W 76/50; H04W 4/50; H04W 4/06; H04W 4/90

(57) ABSTRACT

The present invention provides a method for providing public warning messages to a first user device associated with a second user device, the method comprising storing information connecting the first and second user devices to a single user identity and a preference of a user of the first and second user devices as to whether public warning messages which have been determined to be relevant for one of the first and second user devices should be transmitted to the other one of the first and second user devices; in the event of an event giving rise to an authority issuing a public warning alert, determining if at least one of the first and second devices is in an area indicated to be an area of relevance for the public warning alert.

The present invention relates to the delivery of public warning system messages.

3GPP networks support the public warning system (PWS) which is used to alert the public to events such as disasters. For instance, when earthquakes, tsunamis, hurricanes, volcanic eruptions, wild fires (or similar emergency situations) occur, the PWS may be used to notify people to leave the impacted area within a certain time. As such, dissemination of PWS notifications is usually restricted to a certain region. In case of emergency, PWS messages may be originated by the authorities of a country or district.

Different countries have different requirements on the delivery of warning messages and 3GPP networks support different warning systems for different countries. However, the warning systems supported by 3GPP use a common system architecture and common signalling procedures. That means, PWS messages are originated from a cell broadcast entity (CBE), for example, an entity under control of an authority, such as a meteorological or geological agency, and the like, via a cell broadcast centre (CBC), for example, an entity associated with the mobile network operator's (MNO's) core network, which acts as the information distribution server. From there the PWS messages are propagated only to relevant base stations, that is those deployed in the area where the disaster occurred, of the cellular communication network. The last hop is from the base station(s) to the mobile terminals (UEs) over the air in broadcast mode. 3GPP standardized different warning systems in different releases, according to requests from corresponding countries. Table 1 gives examples of different national and regional warning systems supported by 3GPP LTE.

TABLE 1

| Warning | Target | 3GPP | |
|---|---|---|---|
| System | Region | Release | Remark |
| ETWS | Japan | Rel-8 | SIB-Type 10 (primary) and |
| | | | SIB-Type 11 (secondary) |
| CMAS | United States of | Rel-9 | SIB-Type 12 |
| | America | | |
| KPAS | South Korea | Rel-10 | Minor Variant of CMAS |
| EU-Alert | European Countries | Rel-11 | Minor Variant of CMAS |

The earthquake and tsunami warning system (ETWS) was the first warning system to be standardized in Rel-8 for Japan. The ETWS was designed based on Japanese requirements focusing on earthquakes and tsunamis. The concept of ETWS (and all subsequent warning systems) is very similar to cell broadcasting in WCDMA and GSM networks. In WCDMA, a special channel called CTCH (common traffic channel) was used for this purpose, but in LTE a couple of system information broadcast (SIB) messages were defined to periodically broadcast the warning messages to all the UEs in a certain area simultaneously. Additionally, UEs in the respective areas can be instructed by a special paging message (parameter “ETWS notification” set to “true”) to read and decode the transmitted system information immediately. For example, in LTE, the SIBs carrying the information about ETWS are SIB10 (for the secondary notification) and SIB11 (for the primary notification). Thanks to the broadcast nature of PWS on the air interface the warning messages are not affected by network congestion, and they can be received by UEs residing in RRC_IDLE as well as UEs residing in RRC_CONNECTED mode of operation (if those UEs are able to pick up the respective downlink signals from a base station). The receipt of a broadcast message is usually not acknowledged by the receiving device.

Further details on how ETWS (and all subsequent PWS) work can for instance be found in NTT Docomo's Technology Report Vol. 11.3 under the following link: https://www.nttdocomo.co.jp/english/binary/pdf/corporate/technology/rd/technical_journal/bn/vol11_3/vol11_3_020en.pdf

Currently, tablets and laptops (even if they have a 3GPP subscription) are not required to support rendering of PWS notifications. Support of the PWS feature is only required for mobile devices (user equipment, UE) with a 3GPP subscription that do support voice functionality.

The terms “warning message(s)”, “PWS notification(s)”, and “PWS message(s)” are used interchangeably throughout this document and are meant to represent the same thing.

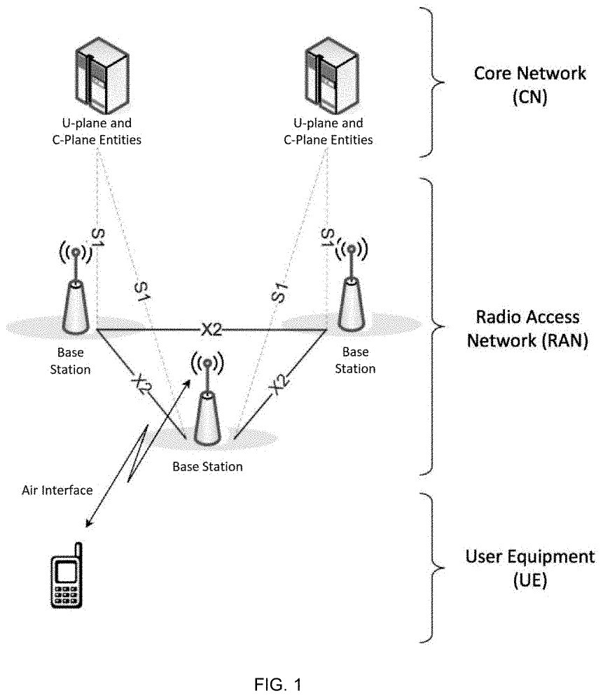

FIG. 1 shows a general architecture of a wireless communication system according to 3GPP. In case of LTE, the most important core network (CN) entities are the serving gateway (S-GW) for handling of user plane traffic and the mobility management entity (MME) for handling of control plane traffic.

The functions of the MME most relevant for the present invention are:
reachability of UEs residing in RRC IDLE mode of operation (including control and execution of the paging procedure);
tracking area list (TAL) management; and
support for PWS message transmission.

In LTE, the radio access network (RAN) is made up of 4G base stations (eNBs). Each eNB has its own S1 connection into the CN. The S1 interface supports a many-to-many relation between MMEs/S-GWs and eNBs. A base station may span multiple cells (or “coverage sectors”). Typically, up to three more or less equally distributed segments of a circle are provided as coverage sectors by a single base station. In many deployment scenarios, these coverage sectors are roughly of the same width (i.e. with opening angles of approx. 120 degrees each).

The S1 connection can be logically subdivided into an S1-U connection for user plane traffic terminating at the S-GW and an S1-C connection for control plane traffic terminating at the MME. Furthermore, eNBs may be interconnected with one another over a (logical) X2 interface. Such X2 connections may physically go through the core network in some cases.

In case of LTE, the wireless interface between an eNB and a mobile terminal (user equipment, UE) is referred to as LTE Uu Interface.

This invention is not restricted to wireless communication systems operating according to 3GPP's LTE suite of specifications (also known as 4G systems). Upcoming 5G wireless communication systems, such as the one developed by 3GPP in course of Rel-15, are explicitly included in the scope of the present disclosure.

PWS in 4G LTE was designed for sending instant emergency and disaster alerts to 4G mobile users. It accommodates the cell broadcast centre (CBC) and cell broadcast entity (CBE) that stem from the cell broadcast service (CBS) network architecture developed for pre-LTE radio communication systems, such as the global system for mobile communications (GSM) and the universal mobile telecommunication system (UMTS).

A warning message may include (among other information elements) a message identifier, a serial number, a warning type, warning message contents and a digital coding scheme.

On the infrastructure side, the warning messages are delivered from the CBE to the LTE base station (eNB) via the CBC and MME. The protocol used between the CBC and the MME is the SBc-AP, while the protocol used between the MME and the (at least one) LTE base station (eNB) is the S1AP. For the air interface, PWS uses different types of system information blocks such as SIB-Type10, SIB-Type11 and SIB-Type12 for message delivery (cf. Table 1).

The distribution areas for PWS can be specified in three different granularities allowing mobile network operators (MNOs) an efficient and flexible broadcast of the warning messages:

### 1) Cell Level Distribution Area

The CBC designates the cell-level distribution areas by sending a list of cell-IDs. The emergency information is broadcast only in the designated cells.

### 2) TA Level Distribution Area

In this case, the distribution area is designated as a list of tracking area identities (TA-IDs). A TA-ID is an identifier of a tracking area (TA), which represents an LTE mobility management area. The warning message broadcast goes out to all of the cells in the TA-IDs.

### 3) EA Level Distribution Area

The emergency area (EA) can be freely defined by the MNO. An EA-ID can be assigned to each cell of the cellular communication system, and the warning message can be broadcasted to the relevant EA only. The EA can be larger than a cell and is independent of the TA concept. The EA thus allows a very flexible design for optimization of the distribution area for the affected area according to the type of disaster.

A figure illustrating the differences between these three distribution area granularities can also be found in NTT Docomo's Technology Report Vol. 11.3 under the link given above.

In case of a disaster or an imminent threat, the CBE may trigger emergency information distribution at the CBC. When the MME receives a “Write-Replace Warning Request” message from the CBC, it sends a “Write-Replace Warning Confirm” message back to the CBC to notify that the initial request message was correctly received. The CBC may then notify the CBE that the distribution request was correctly received, and that its processing in the MNO domain has begun. At the same time, the MME checks the distribution area information in the received message and, if a TA-ID list is included (cf. granularity #2 from the list above), it sends the Write-Replace Warning Request message only to those LTE base stations (eNBs) that belong to the TA-IDs in the list. If the TA-ID list is not included, the message is sent to all LTE base stations to which the MME is connected. When an eNB receives the Write-Replace Warning Request message from the MME, it determines the message distribution area based on the information included in the Write-Replace Warning Request message and starts the transmission of the message in broadcast mode in the relevant cells (cf. definition of “coverage sectors” in the text above). The following describes how the eNB processes each of the specified information elements:

### 1) Disaster Type Information (Message Identifier/Serial Number)

If an on-going broadcast of a warning message exists, this information is used by the eNB to decide whether it shall discard the newly received message or overwrite the ongoing warning message broadcast with the newly received one. Specifically, if the received request message has the same type as the message currently being broadcast, the received request message is discarded. If the type is different from the message currently being broadcast, the received request message shall overwrite the ongoing broadcast message and the new warning message is immediately broadcast.

### 2) Message Distribution Area (Warning Area List)

When a list of cells has been specified as the distribution area, the eNB scans the list for cells that it serves and starts warning message broadcast only in these cells. If the message distribution area is a list of TA-IDs, the eNB scans the list for TA-IDs that it serves and starts the broadcast to the cells included in those TA-IDs. In the same way, if the distribution area is specified as an EA (or list of EAs), the eNB scans the EA-ID list for EA-IDs that it serves and starts the broadcast to the cells included in the EA-ID list. If the received Write-Replace Warning Request message does not contain distribution area information, the eNB broadcasts the warning message to all of the cells it serves.

The PWS system is currently not prepared for 3GPP's upcoming “multi-user/multi-device” initiative. This new work item started in TSG-SA1 working group (first of all, with the discussion of use cases and the definition of requirements). The corresponding work item description (WID) SP-180315 was agreed during 3GPP SA Plenary #80 in June 2018 and can be found at: http://www.3gpp.org/ftp/tsg_sa/TSG_SA/TSGS_80/Docs/SP-180315.zip

The “multi-user/multi-device” feature will allow addressing of multiple user devices that are associated with (or, registered under) a single user identity (metaphorically speaking, some kind of “umbrella identity”). For example, with this new feature incoming calls may be signalled to multiple user devices (e.g., private cell phone and corporate cell phone). It is currently unclear if and how transmission of PWS messages to multiple user devices can be achieved with the current network architecture and signalling flow. The present invention addresses these issues.

U.S. Pat. No. 9,226,125 B2 describes a technique for establishing a data connection with a network alternative to a cellular network for the distribution of PWS messages. WO 2014/027740 A1 describes a warning message delivery procedure in which messages may be delivered to one or more MTC (machine type communication) devices in addition to a UE. U.S. Pat. No. 7,873,344 B2 describes a method of distributing PWS messages over a local area network. US 2009/0247111 A1 describes a method in which warning messages are sent via the internet if a cellular device is temporarily inoperative due to its connection to wireless internet access points.

US 2014/0315511 A1 describes cellular broadcast message forwarding in which a cellular device forwards a cellular broadcast message to other electronic devices over a non-cellular connection such as a local wireless connection. US 20115/0372774 A1 describes the forwarding of a PWS message received by a UE via a cellular network and the forwarding of that PWS message to other UEs via device-to-device communication, for example using the 3GPP ProSe functionality. U.S. Pat. No. 8,010,164 B1 describes the distribution of warning messages by broadcast techniques and by the sending of messages via the short message service if broadcast technology is not supported.

The present invention provides a method for providing public warning messages to a first user device associated with a second user device, the method comprising storing information connecting the first and second user devices to a single user identity and a preference of a user of the first and second user devices as to whether public warning messages which have been determined to be relevant for one of the first and second user devices should be transmitted to the other one of the first and second user devices; in the event of an event giving rise to an authority issuing a public warning alert, determining if at least one of the first and second devices is in an area indicated to be an area of relevance for the public warning alert and if one of the first and second user devices is determined to be in the area of relevance and the other one of the first and second user devices is outside the area of relevance transmitting a public warning message to the other one of the first and second user devices in addition to the user device in the area of relevance.

This invention prepares a PWS system having “multi-user/multi-device” functionality. In detail, the method disclosed enables PWS support for 3GPP's new “multi-user/multi-device” feature. A user can receive PWS notifications on a multitude of his devices. For this at least one new look-up table (for example, in form of a data base) is introduced and administered in the MNO's core network domain. The input parameters needed to find out what other devices have been registered under the user's “umbrella identity” for provisioning of PWS messages are taken from the user's current whereabouts in the system (i.e. from location information that is preferably derived from at least one list of Cell-IDs, TA-IDs, or EA-IDs according to the three levels of distribution area granularity described above). The output parameter to address the user's other devices grouped under an “umbrella identity” (which may be an MNO internal subscriber ID) may for instance be an MSISDN (including MCC and MNC) or a similar identifier.

Alternatively, the data base interrogation may by a two-step procedure: First a subscriber ID is derived from the PWS notification area information (“Whose devices are in the affected tracking area?”), then the parameters for addressing further user devices are derived from the subscriber ID (“Is the subscriber using other devices and are these registered for propagation of PWS notifications?”).

Copies of PWS Notifications for a given user's multiple user devices are then generated and submitted.

Optionally, copies of PWS notifications may be marked as being warning messages for another device and/or that the current location of the receiving device does not fall into the PWS notification area.

The user is enabled to express propagation preferences for handling of PWS notifications. These preferences may be device specific and are ideally stored in the MNO core network domain, too. In one embodiment these preferences are stored in the same data base.

Before presentation of (forwarded) PWS notifications to further user devices additional checks may be performed on the respective device as to whether the user in question is actually logged into the device (e.g., on tablet computers with a valid 3GPP subscription that are shared among family members).

Preferred embodiments of the invention will now be described, by way of example only, with reference to the accompanying drawings in which:

FIG. 1 shows a general network architecture according to 3GPP;

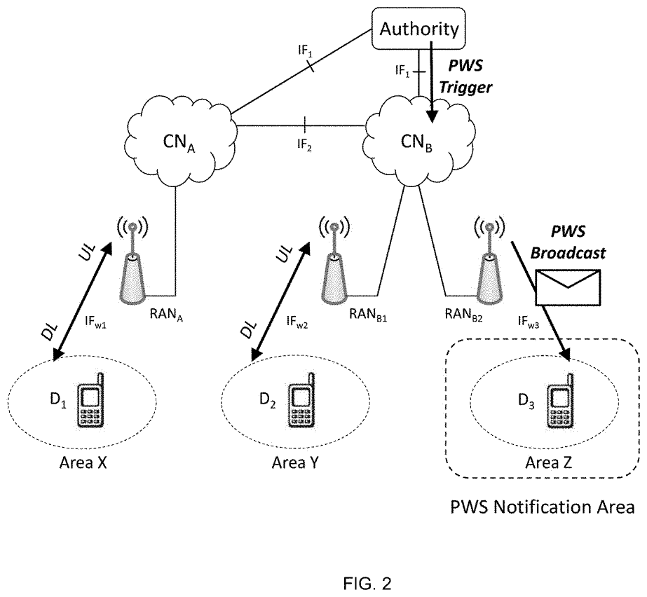

FIG. 2 shows a known network topology and PWS behaviour;

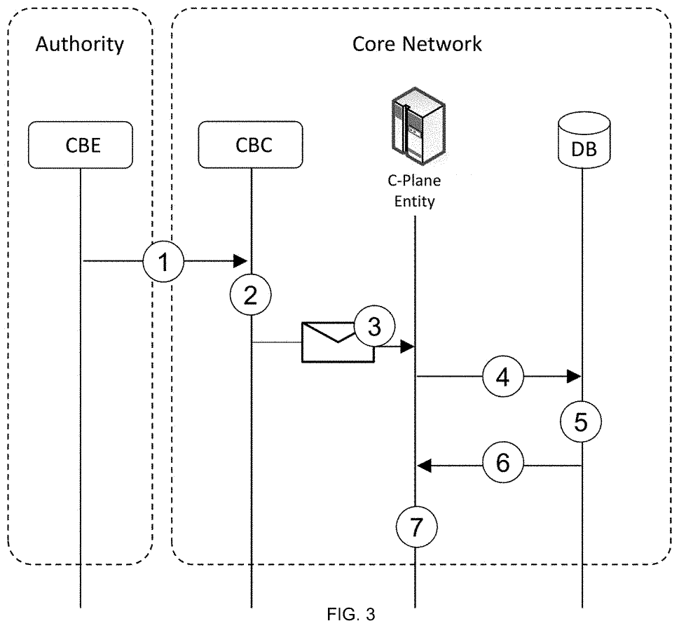

FIG. 3 is a message flow diagram according to one embodiment;

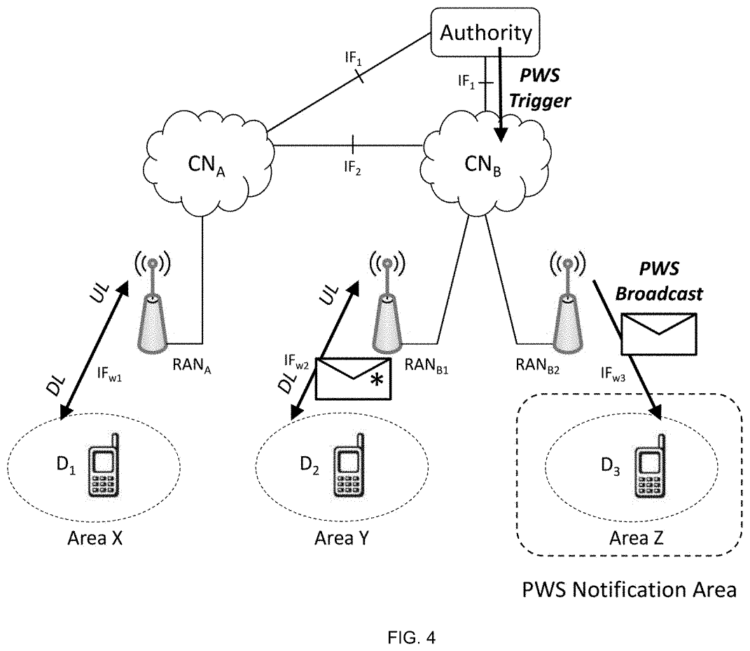

FIG. 4 illustrates schematically message flows according to the embodiment of FIG. 3; and

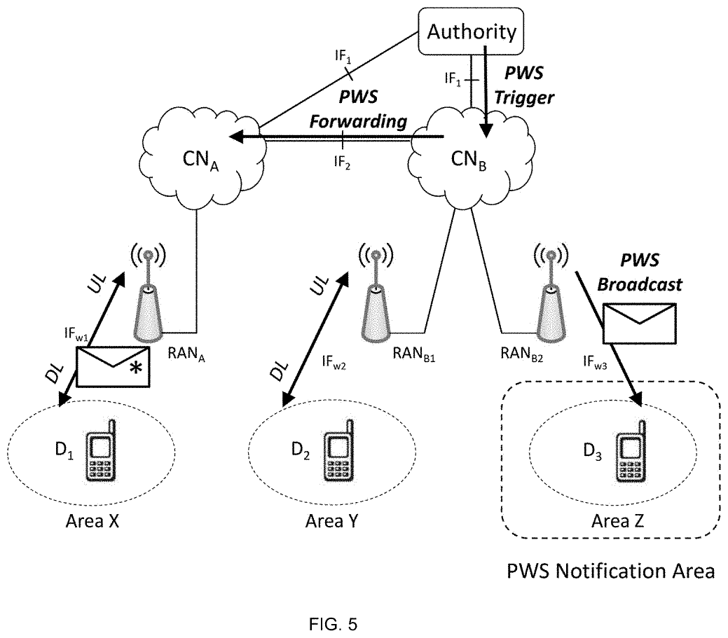

FIG. 5 illustrates schematically message flows according to a second embodiment.

Referring to FIG. 2, a schematic situation is shown. In the following example scenario, a user has left their private cell phone, device D3, behind in their home in the morning. During the day, only a corporate cell phone (device D1 or device D2) is carried.

Both devices are associated with a single user identity (cf. “umbrella identity” described above). The user also stored some user preferences for PWS provisioning, such as “In case of an emergency/disaster I would like to receive PWS notifications on all of the registered devices”, in the MNO domain.

In one example of the present invention the corporate cell phone has a subscription with the same MNO (device D2), in another example it has a subscription with a different MNO (device D1).

Later in the day, a wildfire breaks out in the area where the user's house is located, and the authorities decide to trigger transmission of PWS notifications of type “wildfire warning” (potentially with some more details about the emergency situation) in all affected regions (including coverage area Z) in order to warn people about the imminent threat.

FIG. 2 shows an example network topology according to state-of-the-art. Two wireless communication systems for MNO A and MNO B are depicted. MNO B's coverage area Z is part of the PWS notification area. This is where the user has left their private phone behind.

The original PWS notification triggered by the authorities should be transmitted via broadcasting means (“PWS broadcast” in FIG. 2) to all cell phones residing in the coverage area Z.

FIG. 3 shows an enhanced message flow for the novel proceedings that happen inside the core network of the cellular communication system operated by MNO B:
Step 1: The authority (CBE) triggers the MNO domain via a trigger message to initiate the PWS message transmission procedure. This trigger message may contain at least a message identifier, a serial number, a warning type, the warning message contents and a digital coding scheme. It is received and acknowledged by the CBC.
Steps 2 and 3: Based on this trigger message the CBC generates the actual PWS notification and sends various instances of it to all affected C-plane entities (e.g., MMEs, in case of LTE).
Step 4: According to this invention, a database (DB) query is performed inside MNO B's domain to find out (as part of a first action) whether any of the affected subscribers has enabled the “multi-user/multi-device” functionality and—if so—(as part of a second action) what other devices the PWS notification needs to be forwarded to and (as part of a third action) how these can be addressed. These three actions (or a sub set thereof) may also be combined in one procedural step.
   The input parameters needed to find out what other devices have been registered under the user's “umbrella identity” for provisioning of PWS messages are taken from the user's current whereabouts in the system (i.e. from location information that is preferably derived from at least one list of Cell-IDs, TA-IDs, or EA-IDs according to the three levels of distribution area granularity described earlier).
Step 5: The database may also contain a set of (individual or common) user preferences pertaining to PWS message propagation (such as forwarding rules, notification repetition settings, a hierarchal list of alternative devices, and so on).
Step 6: As a result of a database query (output parameters), the C-plane entity receives a list of subscription identifiers (or identifiers of further devices) that users have previously registered for the “multi-user/multi-device” functionality.
Step 7: Further instances of the PWS message are generated in the MNO B's domain and transmitted to further user devices (potentially taking user preferences for the propagation of PWS messages into account). These further user devices may either have a subscription with MNO B or with other MNOs. In the latter case, one or more PWS forwarding message(s) may be generated (e.g., using the message identifier or the serial number of the warning message as a reference) for propagation to other MNO domains (potentially taking user preferences for the propagation of PWS messages into account).

One aspect of the present invention is to mark the copies of PWS notifications accordingly (cf. the star in the envelope symbol in FIGS. 4 and 5). The marking may also include a user identifier that can be used to verify who is currently using the device if the device in question allows creation of several login accounts (e.g., as in tablet computers shared among family members).

A first example scenario, in which the user's private mobile device D3 (coverage area Z=PWS notification area) and his corporate cell phone D2 (coverage area Y) have subscriptions with the same MNO B, is depicted in FIG. 4.

A second example scenario, in which the user's private mobile device D3 (coverage area Z=PWS notification area) is subscribed with MNO B, while their corporate cell phone D1 (coverage area X) has a subscription with MNO A, is depicted in FIG. 5. Here, a PWS forwarding message is transmitted over the IF₂ interface from MNO B to MNO A. The PWS forwarding message may either contain a copy of the original PWS notification or a reference to the PWS notification that MNO A may have received directly from the authorities via the IF₁ interface.

In both scenarios the respective MNO may choose to use dedicated signalling in coverage areas X and Y (as opposed to broadcast signalling in coverage area Z) to address the relevant mobile devices that are not residing inside the PWS notification area.

Although coverage areas X and Y (serving the user's corporate cell phone) are shown as logically separated coverage areas in FIGS. 4 and 5, they may physically overlap (at least in parts).

If one of the mobile devices is a tablet computer or another device that allows creation of different user accounts, at least one check may be performed according to the method of the invention as to which of the account holders is actually logged into the device. Only if the correct person is logged in, would a PWS notification be displayed/rendered.

1. A method for providing public warning messages to a first user device associated with a second user device, the method comprising:
storing information connecting the first and second user devices to a single user identity and a preference of a user of the first and second user devices as to whether public warning messages which have been determined to be relevant for one of the first and second user devices should be transmitted to the other one of the first and second user devices;
in the event of an event giving rise to an authority issuing a public warning alert, determining if at least one of the first and second devices is in an area indicated to be an area of relevance for the public warning alert and if one of the first and second user devices is determined to be in the area of relevance and the other one of the first and second user devices is outside the area of relevance transmitting a public warning message over a radio access network of a public land mobile network to the other one of the first and second user devices in addition to the user device in the area of relevance.

2. The method according to claim 1, wherein the information is stored in a database maintained in a mobile network operator's core network.

3. The method according to claim 1, wherein the public warning alert transmitted to the other one of the first and second user devices is marked to indicate that it is a copy of public warning alert broadcast in the area of relevance.

4. The method according to claim 1, wherein the public warning alert transmitted to the other one of the first and second user devices is transmitted by a mobile network different to a mobile network serving the one of the first and second user devices.

5. The method according to claim 1, wherein a subscriber identification for a user device within a public warning system notification area is determined and this subscriber identification is used to determine any further user device linked to the user device within the public warning system notification area.

6. The method according to claim 1, wherein the stored information contains user provided preference information for handling public warning system notifications.

7. The method according to claim 1, wherein prior to transmitting the public warning message to the other one of the first and second user devices, a check is made to determine whether a registered user of the one of the first and second user devices is using the other one of the first and second user devices.

8. The method according to claim 2, wherein the public warning alert transmitted to the other one of the first and second user devices is marked to indicate that it is a copy of public warning alert broadcast in the area of relevance.

9. The method according to claim 2, wherein the public, warning alert transmitted to the other one of the first and second user devices is transmitted by a mobile network different to a mobile network serving the one of the first and second user devices.

10. The method according to claim 2, wherein a subscriber identification for a user device within a public warning system notification area is determined and this subscriber identification is used to determine any further user device linked to the user device within the public warning system notification area.

11. The method according to claim 2, wherein the stored information contains user provided preference information for handling public warning system notifications.

12. The method according to claim 2, wherein prior to transmitting the public warning message to the other one of the first and second user devices, a check is made to determine whether a registered user of the one of the first and second user devices is using the other one of the first and second user devices.
